(19) United States
(12) Patent Application Publication
(10) Pub. No.: US 2007/0119407 A1
(43) Pub. Date: May 31, 2007

(54) 8-stroke cycle rotary engine

(76) Inventors: Lung Tan Hu, Aldergrove (CA); An-Tao Anthony Yang, Surrey (CA); Edmund Yang, Surrey (CA); Chun Han Chiang, Surrey (CA); Gordon Ching Chen, Bumaby (CA)

Correspondence Address: Hu Lung Tan, 25755 48th Avenue, Aldergrove, BC, V4W 1J6, CA

(21) Appl. No.: 11/288,784

(22) Filed: Nov. 30, 2005

(51) Int. Cl. F02B 53/04

(52) U.S. Cl. 123/229

(57) ABSTRACT

An 8-stroke cycle rotary engine utilizes a pair of master combustion chamber and slave combustion chamber to increase the fuel-efficiency. 8-stroke cycle includes mater intake stroke, slave intake stroke, master compression stroke, slave compression stroke, master expansion stroke, slave expansion stroke, master-to-slave exhaust stroke, and slave exhaust stroke.

### BACKGROUND

1. Field of the Invention

The present invention relates to an 8-stroke cycle rotary engine. More particularly, the present invention relates to an 8-stroke rotary engine that utilizes a pair of master combustion chamber and slave combustion chamber to increase fuel efficiency.

2. Description of the Related Art

U.S. Pat. No. 4,159,700 mentioned a “Internal combustion compound engines” wherein a multi-cycle piston engine is provided.

U.S. Pat. No. 5,056,471 mentioned a “Internal combustion engine with two-stage exhaust” wherein a multi-cycle piston engine with additional piston for harvesting power from exhaust gas is provided.

U.S. Pat. No. 2,988,065 mentioned a “Rotary internal combustion engine” wherein a four-cycle rotary engine is provided.

U.S. patent application Ser. No. 10/619,147 mentioned a “Eight-stroke internal combustion engine utilizing a slave cylinder” wherein a eight-stroke piston engine is provided.

### SUMMARY OF THE INVENTION

It is well known that four-cycle and other multi-cycle rotary engines produce exhaust gases that contain un-used energy in the form of un-burnt gasses. Many different approaches have been used to both try to capture the un-used energy within these unburned gases and to try to reduce atmospheric emissions caused by inefficient combustion.

The rotary engines also suffers poor efficiency due to its short power stroke and large heat loss surface area.

It is a primary objective of the present invention to provide 8-stroke rotary engine which is fuel-efficient, reliable, and environmental-friendly.

It is also an objective of the present invention to provide an 8-stroke rotary with cooler working temperature to decrease heat loss.

It is also an objective of the present invention to provide an 8-stroke rotary with multiple power stroke.

### BREIF DESCRIPTION OF THE DRAWINGS

FIGS. 1 to 10 are simplified drawings which show a plurality of successive rotational positions of both master combustion chamber and slave combustion chamber in cross-section perpendicular to the axis of rotation;

FIG. 11 and FIG. 12 are simplified structural illustration of the epitrochoids of master combustion chamber and slave combustion chamber and their location relative to each other.

### DETAILED DESCRIPTION OF THE EMBODIMENTS

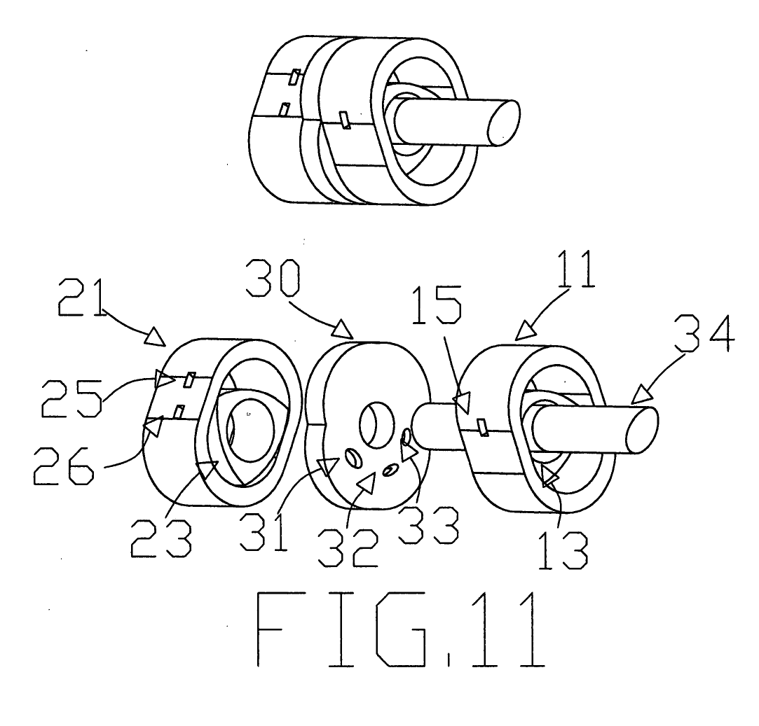

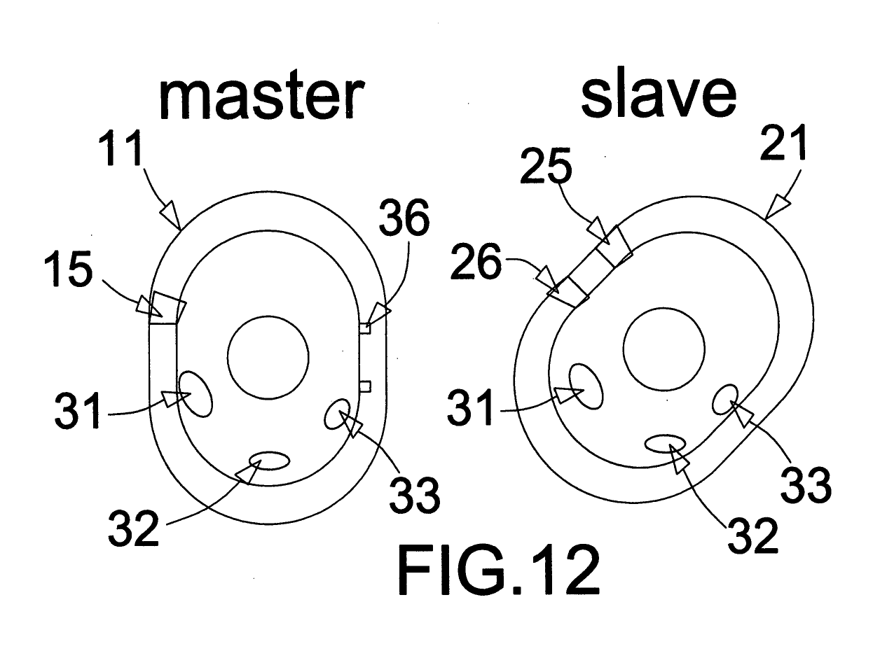

Referring now to FIG. 11 and FIG. 12, the present invention comprises, a master engine housing 11, a slave engine housing 21, a master rotor 13 with three apex portions 14, a slave rotor 23 with three apex portions 24, an intermediate wall 30, a primary coordinating channel 31, a secondary coordinating channel 32, a master-to-slave exhaust channel 33, a master intake port 15, a slave intake port 25, a slave exhaust port 26, an eccentric cam 34 connected with an output shaft (not shown), and ignition means 36.

The 8-stroke cycle rotary engine is generally similar to the type of rotary engine disclosed in the aforementioned patent, therefore it will not be described in detail here beyond what is necessary to disclose the features of the invention. Details such as sealing means, lubrication means, ventilating means, transmission, ring gears and center gears are omitted in the drawings for clarification purpose.

A master engine housing 11 having a master combustion chamber 12 of a multi-lobe profile which is basically an epitrochoid and in which the lobes are joined by regions disposed relatively near to the engine axis;

A slave engine housing 21 having a slave combustion chamber 22 of a multi-lobe profile which is basically an epitrochoid and in which the lobes are joined by regions disposed relatively near to the engine axis;

The master rotor 13 has a generally triangular profile with three apex portions 14 having sealing cooperation with the inner surface of the master engine housing 11 to form three master working chambers between the master rotor 13 and the master engine housing 11. These three master working chambers are distinguished form each other by the reference letters 12a, 12b, and 12c.

The slave rotor 23 has a generally triangular profile with three apex portions 24 having sealing cooperation with the inner surface of the slave engine housing 21 to form three slave working chambers between the slave rotor 23 and the slave engine housing 21. These three slave working chambers are distinguished form each other by the reference letters 22a, 22b, and 22c.

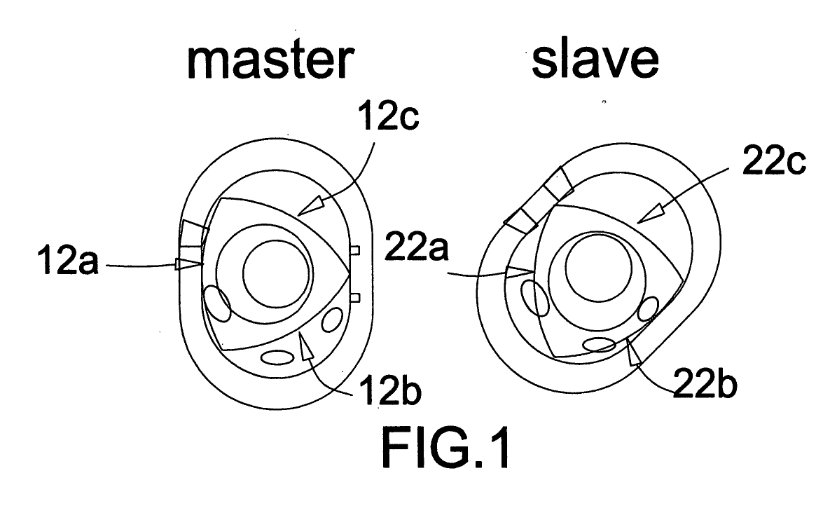

The working cycle of 8-stroke cycle rotary engine is a 8-stroke cycle operated with both the master rotor 13 and the slave rotor 23. Referring now to the drawings, and particularly to FIGS. 1-10, wherein the master combustion chamber 12 and the slave combustion chamber 22 are shown in successive rotational positions, diagrammatically illustrating each phase position of the master rotor 13 and the slave rotor 23.

During the operation of 8-stroke cycle rotary engine, the master working chamber 12a co-acts with the slave working chamber 22a, the master working chamber 12b co-acts with the slave working chamber 22b, the master working chamber 12c co-acts with the slave working chamber 22c. Each master working chamber requires a correspondent slave working chamber to complete its 8-stroke cycle.

In order to clearly explain in a comprehensive manner, the following description of the 8-stroke cycle operation of 8-stroke cycle rotary engine exclusively refers to the master working chamber 12a and the slave working chamber 22a. It should be readily understood that the other two pairs of master working chambers and slave working chambers are operating with identical procedures.

FIG. 1 shows the phase position of the master working chamber 12a at the beginning of the first stroke. During the first stroke, the master working chamber 12a is located adjacent to the master intake port 15. As the first stroke commences, the master working chamber 12a is open to the master intake port 15 and is fed in with air-fuel mixture until the volume of the master working chamber 12a reaches its maximum intake volume, at which point the slave working chamber 12a is closed to the slave intake port 25. At the beginning of the first stroke, the slave working chamber 22a is at half-stroke phase position of the preceding 8-stroke cycle.

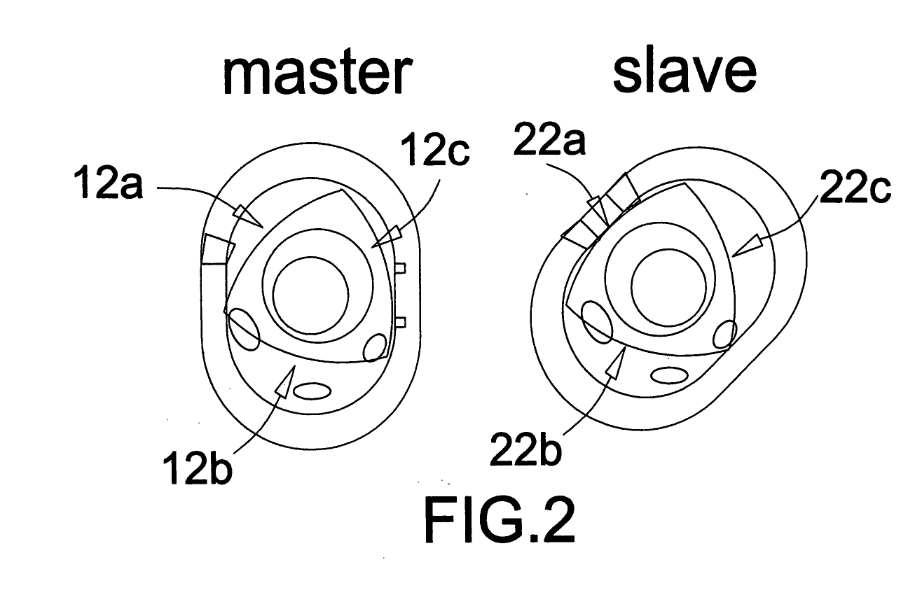

FIG. 2 shows the phase position of the slave working chamber 22a at the beginning of its second stroke. During the second stroke, the slave working chamber 22a is located adjacent to the slave intake port 25. As the second stroke commences, the slave working chamber 22a is open to the slave intake port 25 and is fed in with air until the volume of the slave working chamber 22a reaches its maximum intake volume, at which point the slave working chamber 22a is closed to the slave intake port 25. At the beginning of the second stroke, the master working chamber 12a is at half-stroke phase position of the first stroke.

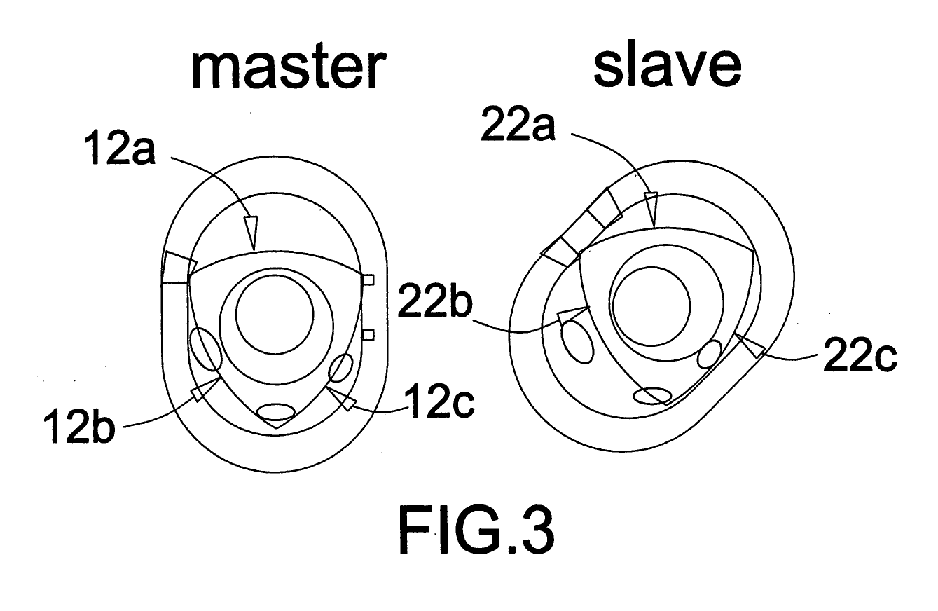

FIG. 3 shows the phase position of the master working chamber 12a at the beginning of the third stroke. As the third stroke commences, the air-fuel mixture inside the master working chamber 12a is compressed, the volume of the master working chamber 12a starts decreasing from a maximum volume condition to a minimum volume condition. At the beginning of the third stroke, the slave working chamber 22a is at half-stroke phase position of the second stroke.

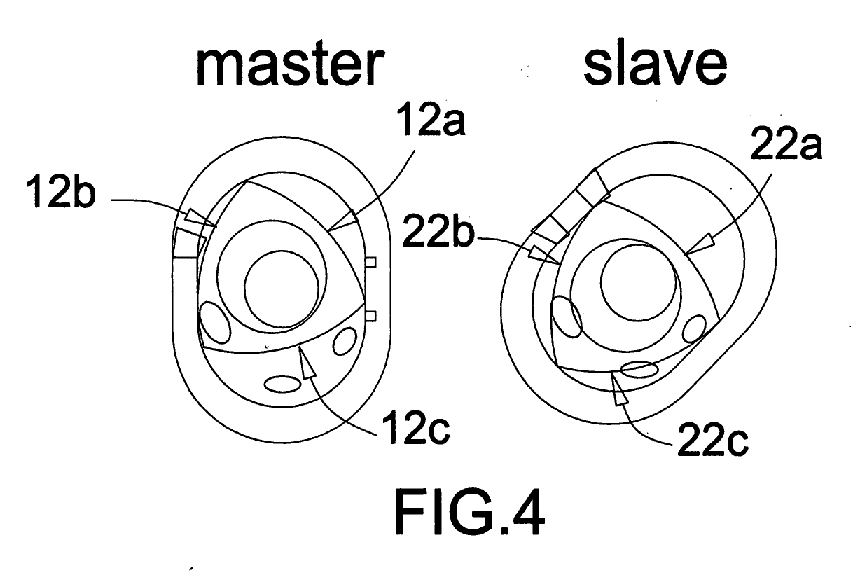

FIG. 4 shows the phase position of the slave working chamber 22a at the beginning of the fourth stroke. As the fourth stroke commences, the air inside the slave working chamber 22a is compressed, the volume of the slave working chamber 22a starts decreasing from a maximum volume condition to a minimum volume condition. At the beginning of the fourth stroke, the master working chamber 12a is at half-stroke phase position of the third stroke.

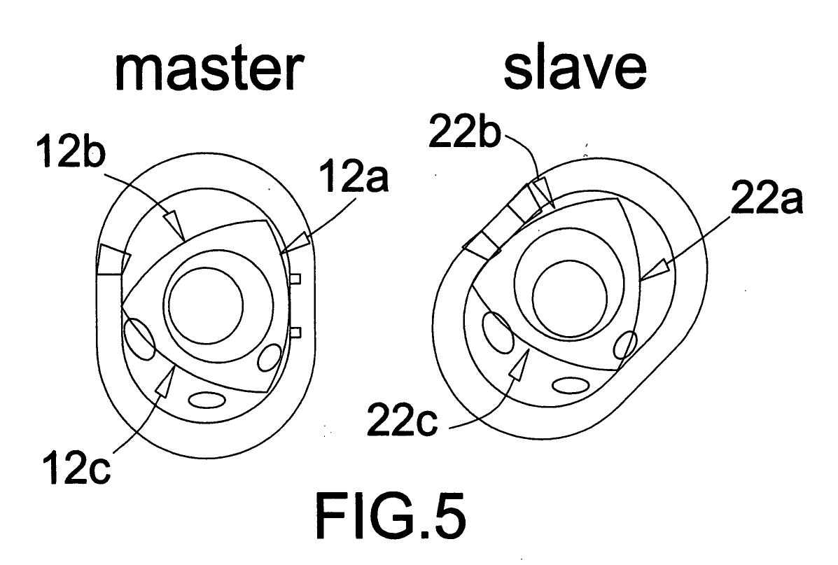

FIG. 5 shows the phase position of the master working chamber 12a at the beginning of the fifth stroke, at which point the master working chamber 12a is located adjacent to ignition means 36 on the inner surface of the master housing 31. When the volume of the master working chamber 12a is compressed to a minimum condition, the compressed air-fuel mixture inside the master working chamber 12a is ignited with ignition means. The master working chamber 12a then goes through the fifth or the first expansion stroke as its volume starts increasing. At the beginning of the fifth stroke, the slave working chamber 22a is at half-stroke phase position of the fourth stroke. After the air-fuel mixture inside the master working chamber 11 is ignited, at approximately one-third stroke phase position of the fifth stroke, the master rotor 13 and the slave rotor 23 are so positioned that the primary coordinating channel 31 is open between the master working chamber 12a and the slave working chamber 22a, thus, the slave working chamber 22a starts pushing the air insid the slave working chamber 22a into the master working chamber 12a to provide more air for expanding and generating the first power stroke to the output shaft 35.

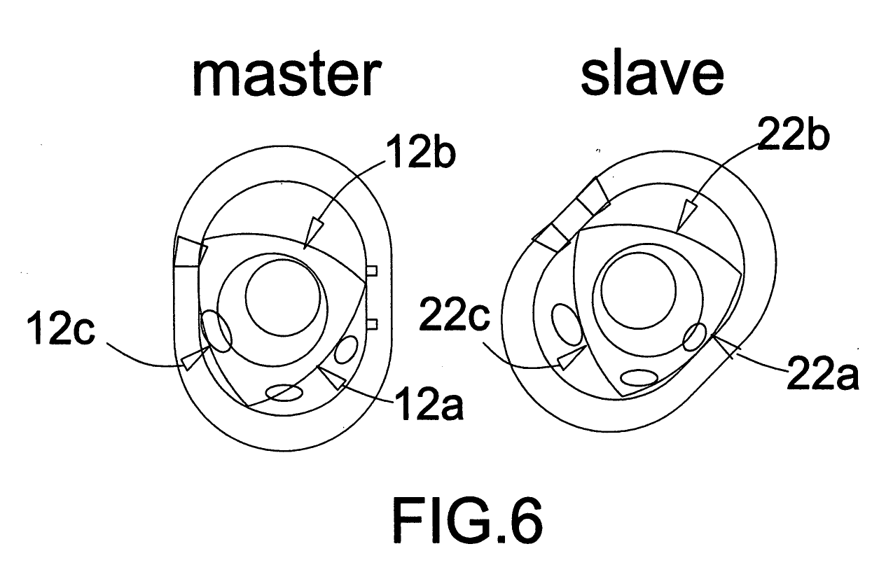

FIG. 6 shows the phase position of the slave working chamber 22a at the beginning of the sixth stroke, at which point the master working chamber 12a is at half-stroke phase position of the fifth stroke, the working medium inside the master working chamber 12a is still expanding, while most of the air inside the slave working chamber 22a is pushed into the master working chamber 12a, and the primary coordinating channel 31 is closed. As the sixth stroke commences, the secondary coordinating channel 32 is open between the master working chamber 12a and the slave working chamber 22a, the working medium then starts to transfer into the slave working chamber 22a and to expand thereto. During the sixth stroke, both the master working chamber 12a and the slave working chamber 22a are expanding and generating the second power stroke to the output shaft 35.

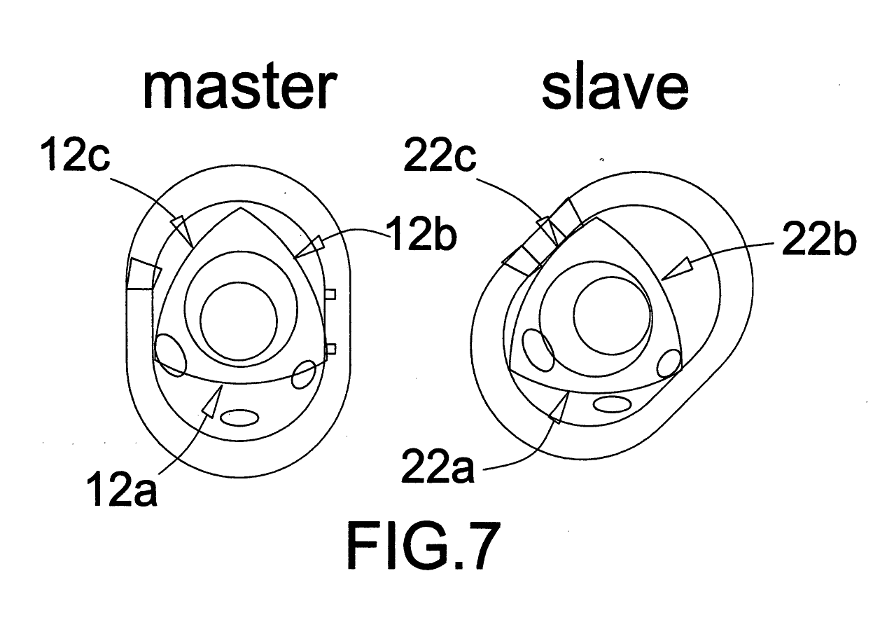

FIG. 7 shows the phase position of the master working chamber 12a at the beginning of the seventh stroke, the master working chamber 12a has expanded to its maximum volume. As the seventh stroke commences, the volume of the master working chamber 12a starts decreasing, and the working medium inside the master working chamber 12a is being pushed into the slave working chamber 22a. At approximately one-third stroke phase position of the seventh stroke, the master-to-slave exhaust channel 33 starts to open between the master working chamber 12a and the slave working chamber 22a, which allows the working medium to exhaust into the slave working chamber 22a at more efficient rate. At the beginning of the seventh stroke, the slave working chamber is at the half-stroke phase position of the sixth stroke, as more working medium is pushed into the slave working chamber 22a, the slave working chamber 22a continues to expand.

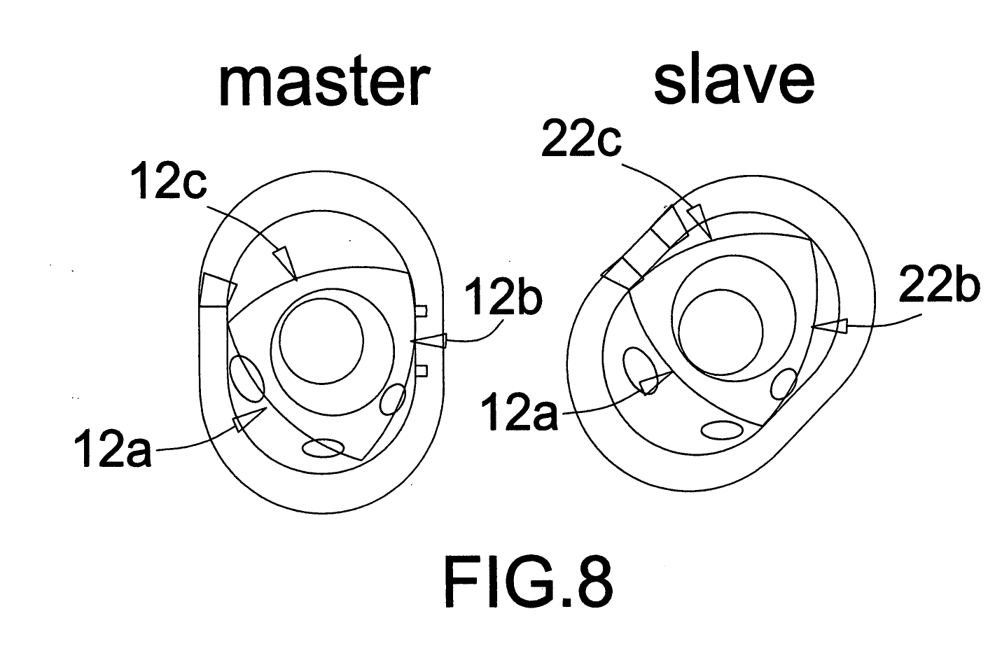

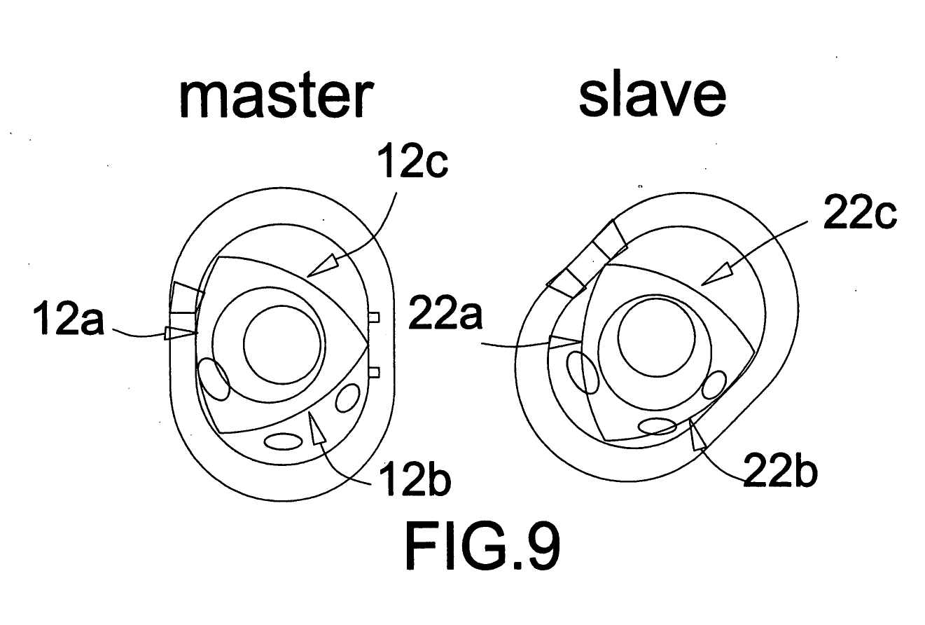

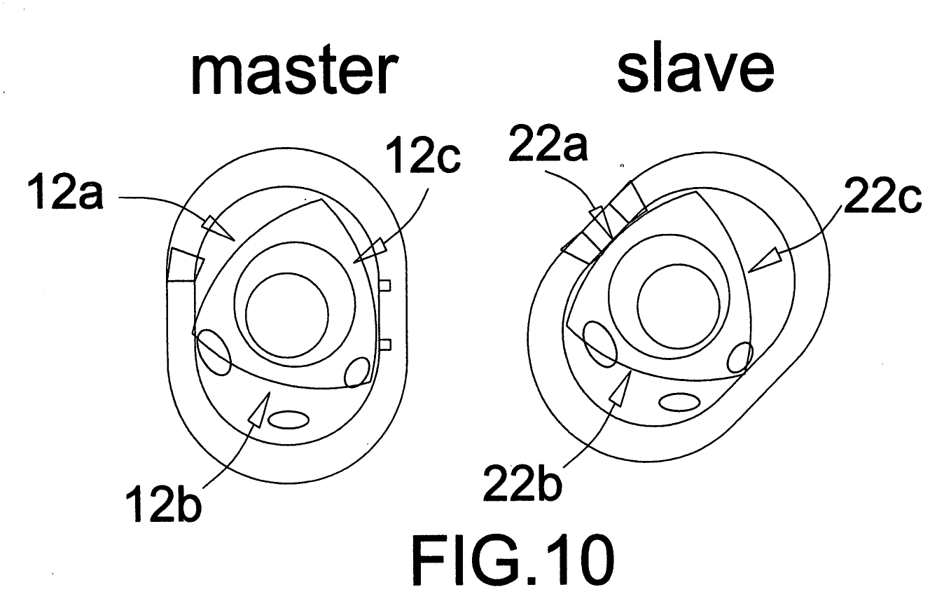

FIG. 8 shows the phase position of the slave working chamber 22a at the beginning of the eighth stroke, the slave working chamber 22a has expanded to its maximum volume, the secondary coordinating channel 32 is starting to close. During the eighth stroke, all the working medium inside the master working chamber 12a is pushed into the slave working chamber 22a, and the working medium inside the slave working chamber 22a is exhausting through the slave exhaust port 26. At approximately one-third phase position of the eighth stroke, the secondary coordinating channel 32 is completely close between the master working chamber 12a and the slave working chamber 22a, then the rest of the working medium inside the master working chamber 12a is pushed into the slave working chamber 22a through the master-to-slave exhaust channel 33. As shown in FIG. 9, at the half-stroke phase position of the eighth stroke, all the working medium inside the master working chamber 12a is transferred to the slave working chamber 22a, and the master working chamber 12a is at the beginning of the first stroke of the next 8-stroke cycle. At the same time, the master-to-slave exhaust channel 33 is closing up, and the working medium inside the slave working chamber 22a continues to exhaust through the slave exhaust port 26. As shown in FIG. 10, all the working medium inside the slave working chamber 22a has exhausted through the slave exhaust port 26, thus it completes the 8-stroke cycle. At the same time, the slave working chamber 22a is at the beginning of the second stroke of the next 8-stroke cycle, and the following procedures are identical to the 8-stroke cycle described above.

According to the amount of air required for the first stroke and the second stroke, a charged intake may be essential for 8-stroke cycle rotary engine.

It should be understood that the invention is not limited to the embodiment described above. Modifications and variations of the embodiment described above will occur to those skilled in the art without leaving the spirit and scoop of the present invention. The scope of the invention is defined with reference to the following claims.

What is claimed:

1. An 8-stroke cycle rotary engine comprising the following combination of components:
(a). A master engine housing having a master combustion chamber of a multi-lobe profile which is basically an epitrochoid and in which the lobes are joined by regions disposed relatively near to the engine axis;
(b). A slave engine housing having a slave combustion chamber of a multi-lobe profile which is basically an epitrochoid and in which the lobes are joined by regions disposed relatively near to the engine axis;
(c). A master rotor of generally polygonal profile having three apex portions and sealing means with surface of said master combustion chamber to form three master working chambers;
(d). A slave rotor of generally polygonal profile having three apex portions and sealing means with surface of said slave combustion chamber to form three slave working chambers;
(e). Said master rotor and said slave rotor are journaled around an eccentric cam which is fixed or preferably integral with an output shaft;
(f). Said master engine housing and said slave engine housing are disposed at approximately 45 degree apart with respect to the axis of said eccentric cam or the engine axis;
(g). At least one ring gear and at least one center gear for synchronizing the rotation of both said master rotor and said slave rotor within said master combustion chamber and said slave combustion chamber respectively;
(h). An intermediate wall disposed between said master combustion chamber and said slave combustion chamber;
(i). At least one primary coordinating channel on said intermediate wall for providing passage between said master combustion chamber and said slave combustion chamber;
(j). At least one secondary coordinating channel on said intermediate wall for providing passage between said master combustion chamber and said slave combustion chamber;
(k). At least one master-to-slave exhaust channel on said intermediate wall for providing passage between said master combustion chamber and said slave combustion chamber;
(l). At least one intake port in the peripheral wall of said master engine housing for intaking air-fuel mixture into said master combustion chamber;
(m). At least one intake port in the peripheral wall of said slave engine housing for intaking air into said slave combustion chamber;
(n). At least one exhaust port in the peripheral wall of said slave engine housing for exhausting air from said slave combustion chamber into an exhaust pipe;
(o). Ignition means for initializing combustion in said master combustion chamber;
whereby during operation of said 8-stroke rotary engine, each said master working chamber co-act with its correspondent slave working chamber, and each stroke leads the following stroke by approximately half-stroke time;
wherein said 8-stroke rotary engine having a operation cycle including the eight strokes of master intake stroke, slave intake stroke, master compression stroke, slave compression stroke, master expansion stroke, slave expansion stroke, master-to-slave exhaust stroke, and slave exhaust stroke;
said master intake stroke intakes air-fuel mixture into one master working chamber,
said slave intake stroke intakes air into its correspondent slave working chamber;
said master compression stroke compresses the air-fuel mixture inside said master working chamber;
said slave compression stroke compresses the air inside said slave working chamber;
said master expansion stroke ignites and expands the air-fuel mixture inside said master working chamber, and the air inside said slave working chamber is pushed into said master working chamber through said primary coordinating channel after the ignition inside said master working chamber;
said slave expansion stroke ignites and expands the remaining air left in said slave working chamber by the working medium transferring from said master working chamber through said secondary coordinating channel;
said master-to-slave exhaust stroke exhausts the fully expanded working medium in said master working chamber to said slave working chamber;
said slave exhaust stroke exhausts all the working medium into said exhaust pipe through said exhaust channel, and the first stroke of the next 8-stroke cycle commences in said master working chamber.

2. An 8-stroke cycle rotary engine as defined in claim 1 further comprises a charge-intake.

3. An 8-stroke cycle rotary engine as defined in claim 1 wherein no ignition means is provided and utilizes self-igniting fuel.

4. An 8-stroke cycle rotary engine as defined in claim 1 wherein said ring gear and said center gear is used as a fluid pump.

5. An 8-stoke cycle rotary engine as defined in claim 1 wherein said master rotor is co-acting with more than one slave rotor.

6. An 8-stroke cycle rotary engine as defined in claim 1 wherein a valve is provided within said primary coordinating channel to regulate the flow of working medium.

7. An 8-stroke cycle rotary engine as defined in claim 1 wherein a valve is provided within said secondary coordinating channel to regulate the flow of working medium.

8. An 8-stroke cycle rotary engine as defined in claim 1 wherein a valve is provided within said master-to-slave exhaust channel to regulate the flow of working medium.

9. An 8-stroke cycle rotary engine as defined in claim 1, wherein said master engine housing and said slave engine housing can be constructed at 30 degree to 60 degree apart with respect to the axis of said eccentric cam or the engine axis, and adjust the timing of each stroke by extending each associated coordinating channel to appropriate position according to the working procedure of said 8-stroke cycle rotary engine.
